(19) United States
(12) Patent Application Publication
(10) Pub. No.: US 2003/0100269 A1
(43) Pub. Date: May 29, 2003

(54) Power control in radio system

(76) Inventors: Otto-Aleksanteri Lehtinen, Raisio (FI); Kalle Passoja, Laukaa (FI)

Correspondence Address: PILLSBURY WINTHROP, LLP, P.O. BOX 10500, MCLEAN, VA, 22102, US

(21) Appl. No.: 10/291,764

(22) Filed: Nov. 12, 2002

Related U.S. Application Data
(63) Continuation of application No. PCT/FI01/00450, filed on May 10, 2001.

(30) Foreign Application Priority Data
May 12, 2000 (FI) 20001142

(51) Int. Cl. H04B 17/00; H04B 1/00; H04B 7/00

(52) U.S. Cl. 455/69; 455/67.1

(57) ABSTRACT

A radio system comprising one or more network parts and one or more terminals in radio connection to the network part, radio traffic on the radio connection between the network part and the terminal being transmitted in a frame, the network part being arranged to allocate downlink transmission power in at least one timeslot to a given terminal from timeslots determined by said frame. The network part of the radio system is arranged to produce the transmission power of a transmission to a terminal timeslot-specifically such that the power ratio of the transmission power of a radio transmission to the terminal in each timeslot and the interference power caused by transmissions to other terminals exceeds a threshold value preset on the power ratio in the timeslot.

### This application is a Continuation of International Application PCT/F101/00450 filed on May 10, 2001, which designated the U.S. and was published under PCT Article 21(2) in English.

### FIELD OF THE INVENTION

The invention relates to radio systems and particularly to power control in radio transmission between a base station in a radio system and a terminal in the coverage area of the base station.

### BACKGROUND OF THE INVENTION

In a radio system, power control refers to adjusting the transmission power of a radio transmission within a given range of variation. Power control is primarily needed to minimize interference caused to each other by terminals located within the coverage areas of base stations in a radio system and to optimize power consumption in terminals. The transmission power of both a base station in a radio network and a terminal in the coverage area of the base station can be adjusted. Transmission power can be adjusted for example in accordance with the principles of an open loop or a closed loop. For example, in the UMTS (Universal Mobile Telephony System) cellular radio system using code division multiple access (CDMA), the closed loop method is used in the downlink TDD (Time Division Duplex) mode, whereby a terminal uses a special power control command (TPC, Transmission Power Control) to state the need to adjust the power of a received transmission. In this case, the terminal can for example notify the base station that the following transmission should have a 1-dB higher power level than a recently received transmission. In uplink TDD in UMTS, the open loop power control principle is used, whereby the receiver, i.e. a terminal, knows which transmission power the base station used in transmitting the transmission, and, having measured the reception power, is able to deduce the attenuation on the radio path and, consequently, based on the reception power, adjust its transmission power utilizing the reciprocity of the link.

Services transferred in radio networks, such as mobile networks, require different quality characteristics of a radio transmission. For example, speech transfer does not need much bandwidth but is sensitive to the delay characteristics of the transmission. A video image, in turn, requires abundantly bandwidth, but the quality of the transmission is not as critical to the delay in the transmission as is speech. For example in the TDD mode in UMTS, bandwidth is allocated by allocating data transfer capacity to users in several timeslots of a transmission frame. In a prior art solution, downlink transmission power is the same for all user data transfer resources within one frame.

It is thus apparent that the prior art involves drawbacks. A downlink radio transmission does not take into account the different quality requirements since the transmission has the same transmission power in all the user's timeslots. The prior art does not either take into account the number of users or the variation of services in timeslots.

### BRIEF DESCRIPTION OF THE INVENTION

The object of the invention is to provide an improved method for power control in a radio system. This is achieved by a method for power control in a radio system, in which radio system a radio transmission between a network part in the radio system and terminals located in the coverage area of the network part is transmitted in a frame, the method comprising allocating downlink transmission power for a terminal in one or more timeslots determined by said frame, and producing transmission power in a transmission to the terminal timeslot-specifically such that the power ratio of the transmission power of a radio transmission to the terminal in the timeslot and the interference power caused by transmissions to other terminals exceeds a threshold value set on the power ratio in the timeslot.

The invention also relates to a network part in a radio system, arranged to transmit radio traffic to terminals located in the coverage area of the network part in a frame, the network part being arranged to allocate downlink transmission power in at least one timeslot to a given terminal from timeslots determined by said frame, wherein the network part is arranged to produce transmission power in a transmission to a terminal timeslot-specifically such that the power ratio of the transmission power of a radio transmission to the terminal in each timeslot and the interference power caused by transmissions to other terminals exceeds a threshold value preset on the power ratio in the timeslot.

The invention also relates to a radio system comprising a network part and one or more terminals in radio connection to the network part, where radio traffic on the radio connection between the network part and the terminal is transmitted in a frame, and where the network part is arranged to allocate downlink transmission power in at least one timeslot to a given terminal from timeslots determined by said frame, wherein the network part is arranged to produce transmission power in a transmission to a terminal timeslot-specifically such that the power ratio of the transmission power of a radio transmission to the terminal in each timeslot and the interference power caused by transmissions to other terminals exceeds a threshold value preset on the power ratio in the timeslot.

Thus, the invention relates to a method and an apparatus for power control in a radio system. In the description of the invention, a radio system preferably refers to a mobile network, even though the invention is not restricted thereto. In the method, the transmission power of a downlink transmission of a network part in the radio system and terminals located in the coverage area of the network, i.e. a transmission from the network part to the terminals, is adjusted. In the description of the invention, a network part refers to an entity formed from one or more base stations and/or one or more base station controllers controlling a base station. The terminal is preferably a mobile station but may also be some other radio receiver and/or device provided with transmitter characteristics, such as a computer, domestic appliance or the like. In connection with UMTS, a terminal refers for example to a device comprising both TE (Terminal Equipment) and UE (User Equipment) functionalities.

The invention relates to radio systems in which at least two downlink data transfer resources can be allocated time-dividedly to each terminal. The invention preferably relates to a radio system that is a hybrid system using code division (CDMA) and time division (TDMA) multiple access methods, whereby a data transfer resource refers to a combination of a timeslot and a spreading code. Furthermore, the invention is preferably applied to a radio system using time division duplex (TDD) without, however, being restricted thereto, but the invention is also applicable to a radio system using frequency division duplex (FDD), provided it comprises TDMA type of characteristics, i.e. resources are allocated time-dividedly or discontinuously.

In a preferred embodiment of the invention, radio traffic is sent to a terminal in a frame, transmission power being allocated to the terminal in at least two timeslots from the timeslots determined by said frame. Before transmission, a threshold value for the quality of the connection is generated in the base station timeslot-specifically and terminal-specifically. Quality is determined for example as a power ratio P_{w}/Pᵢ, wherein P_{w} refers to the transmission power of a transmission addressed to a user in a timeslot and Pᵢ refers to the transmission powers of transmissions addressed to other users in said timeslot. The threshold value 0.10, for example, may be set on the power ratio, whereby the power P_{w} of a transmission addressed to a terminal is 1/10 of the entire transmission power of the timeslot. In an embodiment of the invention, the setting of the threshold value is affected by the service to be sent in the timeslot, for example such that the threshold value is higher for a data transmission than for a video image. In a preferred embodiment of the invention, the service class of the terminal affects the determination of the threshold value. In this case, for example, higher threshold values for the transmission power in a timeslot are set on a terminal subscriber who wants to be placed in a higher service class. Before the frame is sent, the base station equalizes the transmission powers of the frame based on traffic timed, i.e. scheduled, to the frame. The base station uses the scheduled traffic to equalize the transmission power of a transmission to the terminal such that the threshold value for the terminal in the timeslot is fulfilled. Said power level threshold value and estimates of scheduled traffic are an important tool when the radio network estimates if new terminals requesting connection can be offered the services desired by them.

In a preferred embodiment of the invention, the base station uses for transmission power determination, not only estimates of scheduled traffic, but also information obtained from the terminal, such as power control commands and measurement reports related to connection quality. In an embodiment of the invention, the downlink closed power control loop implemented by means of a power control command is implemented by the terminal measuring the signal-to-interference ratio in one such timeslot in which transmission power is allocated to the terminal and transmits a power control command in an uplink transmission to the base station, should power need to be adjusted. The need to adjust power can be determined in the terminal for example by comparing the signal-to-interference radio with the threshold value of the signal-to-interference ratio, which is received for example from the base station upon set-up of the connection or which is generated in the terminal. It is essential to the invention that the power control command related to one timeslot and received from the terminal is utilized in the base station for power control in all the timeslots in which transmission power is allocated to the terminal. In this case, one power control command can be used to handle several downlink resources in different timeslots. In an embodiment of the invention, the timeslot in which the measurements are made in the terminal is the last timeslot in the frame wherein transmission power is allocated to the terminal. The timeslot in which the measurements are made can also be signalled from the base station to the terminal upon set-up of the connection. Power control may continue in the base station based on measurement reports sent by the terminal. In an embodiment, the measurement report contains the measurement results of the signal-to-interference ratio of all timeslots of a previous frame.

The invention provides significant advantages in reducing interference in a radio network, since the transmission power of each timeslot is set separately, whereby transmission to all timeslots does not have to be at the same power level.

### BRIEF DESCRIPTION OF THE DRAWINGS

In the following, the invention will be described in detail in connection with preferred embodiments with reference to the accompanying drawings, in which

FIG. 1 shows a mobile network,

FIG. 2 is a method diagram of an embodiment of the method of the invention,

FIG. 3 is a structural view of a data transfer frame,

FIG. 4 shows an embodiment of the method of the invention,

FIG. 5 shows a base station according to an embodiment of the invention.

### DETAILED DESCRIPTION OF THE INVENTION

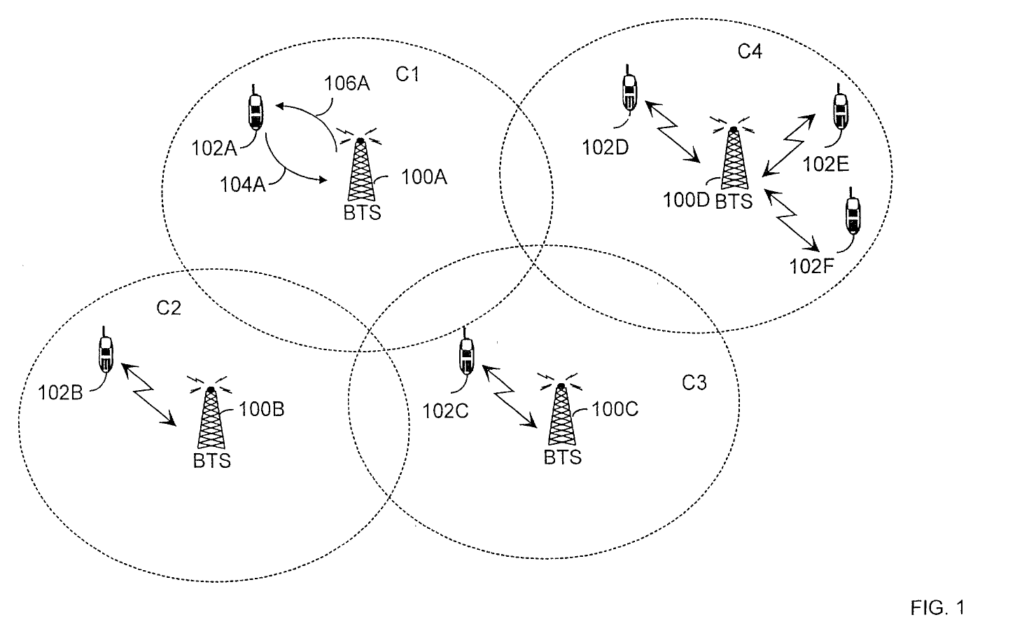

In the following, the invention will be described in detail in connection with preferred embodiments with reference to the attached FIGS. 1 to 5. The description is based on a wideband UMTS system implemented with the direct sequence technique and employing the code division multiple access method, without, however, restricting the invention thereto. The invention is also preferably usable in other radio systems using for example a combination of the time and code division multiple access methods (TDMA/CDMA). The description of the invention is based on the TDD mode of the terrestrial radio network UTRAN of UMTS, operation being in one frequency band, wherein uplink and downlink utilize the same radio frequency but different timeslots in said frequency band. The invention is also usable in systems using FDD, wherein different frequency ranges are defined for uplink and downlink. In the following description, the term base station refers to an entity formed by one or more base stations and/or one or more base station controllers.

FIG. 1 is a schematic view of a mobile system, i.e. a cellular radio system comprising base stations 100A to 100D. The coverage area of a base station is called a cell, which is denoted by C1 to C4 in the figure, corresponding to base stations 100A to 100D. Cells may overlap, such as cell C2 in the figure, which partly overlaps cells C1 and C3. The figure shows one or more receivers 102A to 102F in the area of each cell C1 to C4, the receivers being e.g. mobile stations, but they may be other apparatuses too, which are provided with radio receiver and/or transmitter characteristics and TE/UE functionality. In a radio network using the code division multiple access method (CDMA), such as a mobile network, all users use the same frequency band simultaneously. Users are distinguished from each other based on a spreading code by which the information sent by the user is multiplied. In this case, information, such as a bit stream containing speech, is spread into a wide frequency band. The bit rates of the spreading codes used are significantly higher then that of the data stream to be sent, e.g. 4, 8 or 16. The aim is to select orthogonal spreading codes for users, whereby they do not correlate. In practice, spreading codes are not completely orthogonal, and hence users interfere with each other's transmissions. Interference is caused for example to users communicating in the same timeslot and being located in the same cell or in adjacent cells. The transmission of a user communicating in an adjacent timeslot may also be interfered with. In FIG. 1, receivers 102D to 102F in cell C4 interfere with one another and experience interference from terminals 102A to 102C located in the areas of the other cells C1 to C3. Additional interference between terminals 102A to 102F is caused by the signal transmitted by each terminal propagating along several different paths to the receiver. Due to this multipath propagation, a user signal arrives at the receiver as signal components delayed in several different ways thus causing interference to other users.

FIG. 1 shows a bi-directional radio link 104A to 106A between terminal 102A and base station 100A in cell C1. Transmission from terminal 102A to base station 100A is called uplink 104A and transmission from base station 100A to terminal 102A downlink 106A. In the TDD mode of UMTS, the power of a radio transmission of terminals 102A to 102F and base stations 100A to 100D is adjusted in downlink using a closed loop and in uplink using an open loop. Downlink closed loop power control means that terminal 102A sends a power control command to the base station, based on which base station 100A adapts its transmission to terminal 102A. Uplink open loop power control, in turn, means that terminal 102A measures the transmission power of a transmission received from base station 100A, uses the reception power to deduce the propagation loss and, based on this, adjusts the uplink transmission power to optimal.

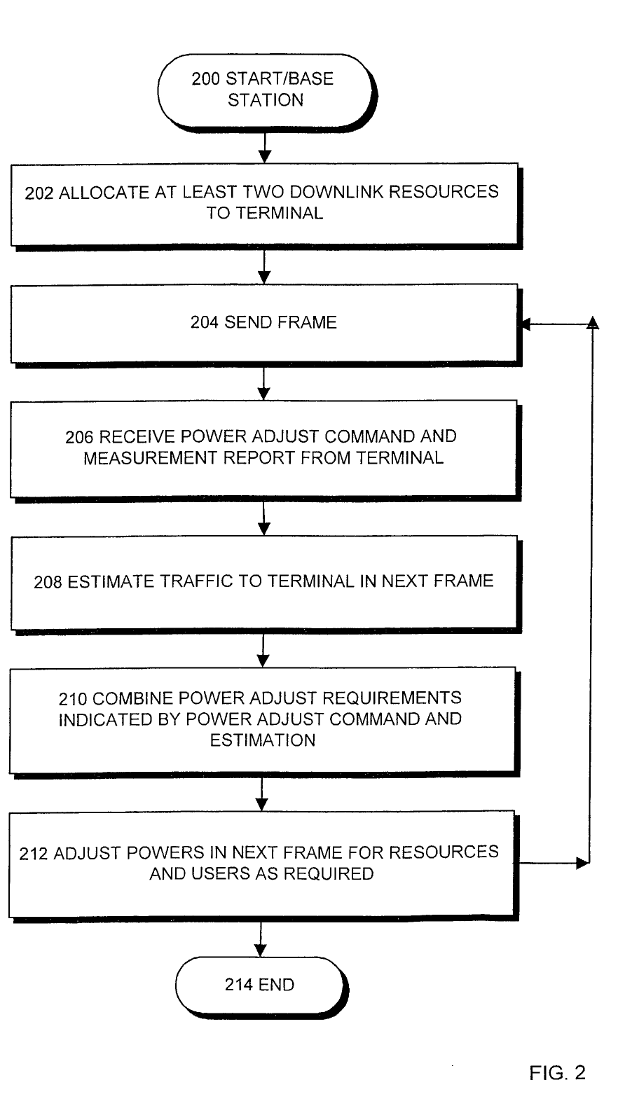

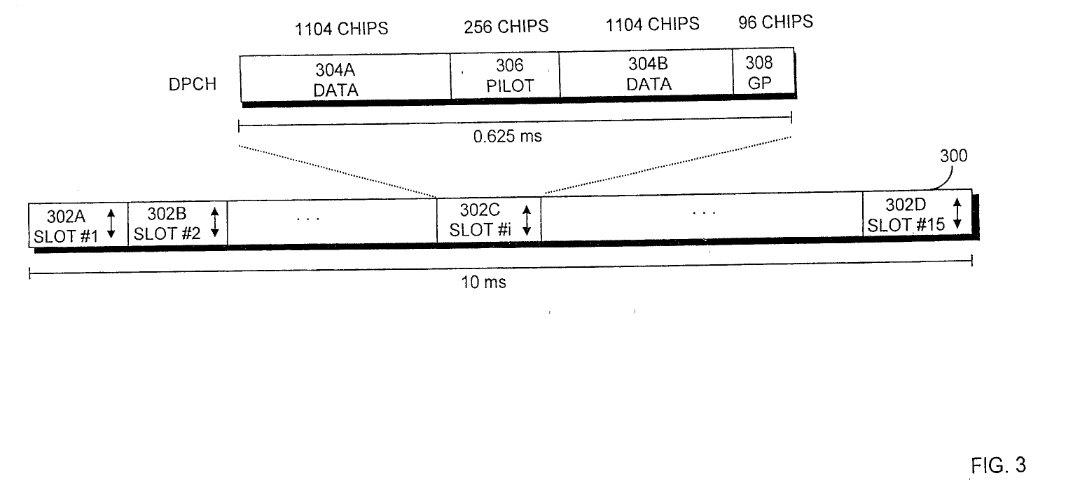

FIG. 2 describes an embodiment of the method of the invention. In the initial method step, a terminal is within the coverage area of a base station and requests a data transfer connection, or, alternatively, the base station requests connection set-up from the terminal. In accordance with step 202, the connection to be set up is such that at least two downlink data transfer resources are allocated. In the TDD mode of UMTS, for example, this would mean that a downlink data transfer frame to be transmitted from the base station, at least two time-dividedly spread data transfer resources are reserved for the terminal. Spreading codes are preferably allocated to different timeslots of the frame, but may be in the same timeslot. Since services requiring different quality characteristics may be transferred in the resources to be allocated, the quality criteria set on the different resources may differ from each other. Services are allocable to timeslots for example by transferring services requiring similar quality characteristics in timeslots. This allows a quality criterion to be preferably set for a timeslot, for example such that the desired transmission power P_{w} of the timeslot is to be at least 5% of the power Pᵢ allocated to other users in the timeslot. In method step 204, the base station sends to terminals within its coverage area a data transfer frame whose structure is described in detail in FIG. 3. In method step 206, the base station receives a power adjust command and/or a measurement report on the quality of the connection from the terminal. Said power adjust command is separately received at the base station, for example by receiving the power adjust command in connection with an uplink timeslot of a traffic channel, whereas measurement reports are preferably sent on control channels. A power adjust command is preferably based on a given timeslot that is known in both the base station and the terminal. In a preferred embodiment, the timeslot to which the power adjust command sent by the terminal relates is the last timeslot in a frame from which transmission power is allocated to the terminal. Furthermore, in an embodiment, the base station sends an indication to the terminal about the timeslot concerning which the power adjust command is to be sent in closed loop power control. In a measurement report concerning a radio link, the terminal sends for example signal-to-noise ratios experienced in all timeslots of a frame.

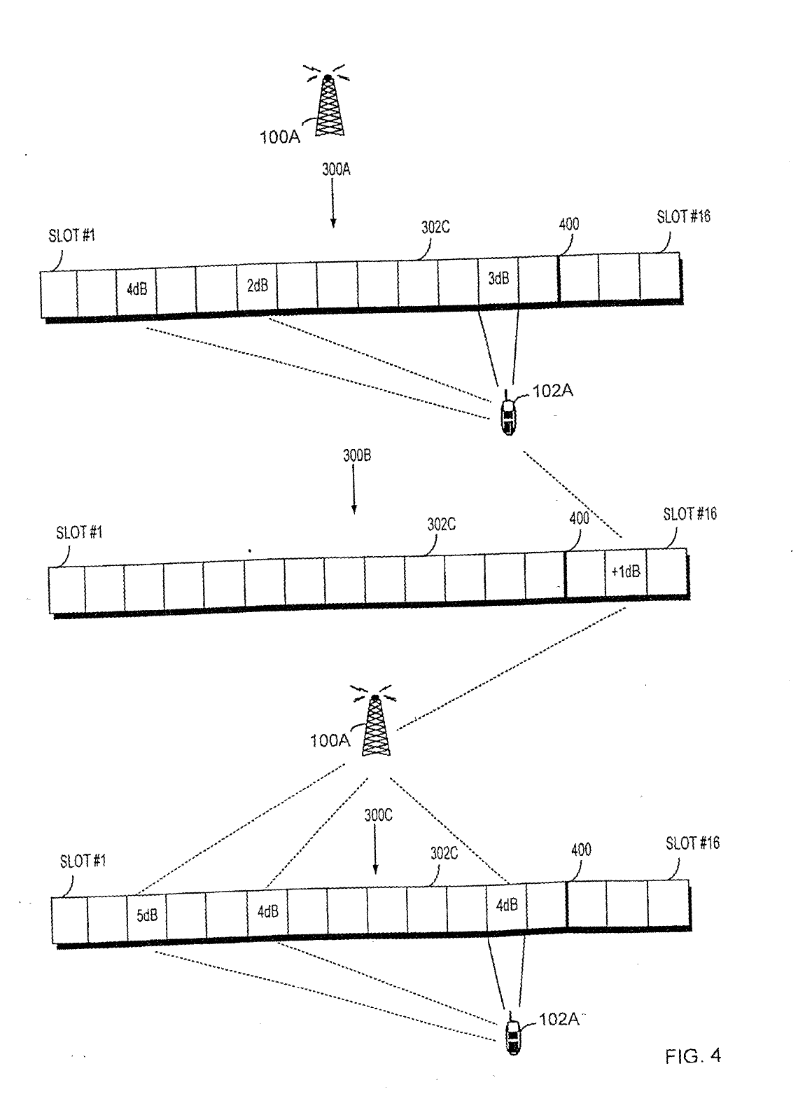

In method step 208 in FIG. 2, the traffic of the frame to be sent next is estimated at the base station. As regards a given terminal, this means for example that in each timeslot, the power ratio P_{w}/Pᵢ exceeds a base station threshold value preset for the timeslot. For example, the service to be sent in the timeslot affects the base station threshold value of the timeslot. In method step 210, the power change requirements created by the power adjust command and the estimate of traffic carried out in method step 208 are combined. Power adjustment requirements can be combined in several ways, and the invention is not restricted to one manner of combination. An example is, for example, that the power adjustment requirements caused by the estimation are created first, and the power adjust commands sent by the terminal are added to them or subtracted from them. In a second preferred embodiment, the power adjust commands sent by the terminal are primarily taken into account, and the power adjustment requirements caused by the estimation are then taken care of, if need be. However, as far as the invention is concerned, it is essential that one power control command per frame be received at the base station. The received power control command is extended to cover all those timeslots in the frame to be sent next, in which resources are allocated to the terminal. For example, power control command +1 dB received at the base station related to timeslot 5, but the +1-dB power control is carried out on all timeslots, e.g. 3, 4 and 5, in which transmission power is reserved for the terminal. This power control is described in detail in connection with FIG. 4. The actual power control is carried out in method step 212 before the next frame is sent by returning to step 204.

In digital radio systems, the radio interface between a terminal and a base station is implemented with logical radio channels, which are physically implemented by means of physical radio channels. Logical channels can be divided into dedicated and common channels, dedicated channels being reserved particularly for communication between a given terminal and base station. An example of a dedicated channel is a dedicated traffic channel DCH (Dedicated Channel). A common channel is used for example to transfer information from a base station to several terminals at the same time. Examples of common channels include BCCH (Broadcast Channel), which is used for downlink transfer of information about a cell to terminals; PCCH (Paging Channel), which is used to request location data from a terminal when the system is not aware of the location of the terminal; RACH (Random Access Channel), which a terminal can be used for uplink transfer of control information for example relating to the set-up of a connection.

Logical channels are implemented with physical channels, whose implementation in a TDMA-based system is a timeslot and a burst to be sent in the timeslot. The frame and burst structures used on physical channels differ depending on the physical channel the transmission takes place on. The frame structure of a physical channel of the TDD mode DPCH (Downlink Dedicated Physical Channel) of UMTS will be described by way of example with reference to FIG. 3. The transmission duration of frame 300 is 10 milliseconds and it is divided into 15 timeslots 302A to 302D, each timeslot, e.g. 302C, having a duration in time of 0.666 milliseconds. Each timeslot 302A to 302D can be allocated simultaneously to several different users who are distinguished from each other by spreading codes. Each timeslot 302A to 302D of a frame can be allocated for either uplink or downlink transmission, which is illustrated by two-headed arrows in timeslots 302A to 302D. However, in each frame preferably at least one timeslot is allocated to the uplink and one to the downlink transmission direction. A data packet to be sent in timeslots 302A to 302D is called a burst, which comprises 2560 chips, i.e. units of the spreading code used. The bursts in one timeslot can be addressed to different users according to spreading codes, but they can also all be addressed to the same user. Eight bursts belonging to different users can be placed in one uplink timeslot. Nine or ten bursts can be placed in one downlink timeslot. In a DPCH burst according to FIG. 3, chips 0 to 1103 contain a first data partition 304A, chips 1104 to 1359 contain a midamble 306, chips 1360 to 2463 a second data partition 304B and at the end of the burst is a 96-chip long guard period 308. The TPC is placed in the middle of midamble 306 and the second data partition 304B, if it is used on the connection. A burst including the described contents is usable for example on a downlink channel. The middle of a burst used on an uplink channel is usually longer in order to facilitate the sorting of bursts coming to a base station from different users and to identify interference caused on the radio path.

FIG. 4 illustrates the efficiency of the method of the invention in practice. Uppermost in the figure is frame 300A, which is sent from base station 100A to terminals communicating with it, such as terminal 102A. Frame 300A is composed of 16 timeslots, of which timeslots 1 to 13 are reserved for downlink and timeslots 14 to 16 above duplex limit 400 to uplink. Transmission power is allocated to terminal 102A from timeslots 3, 6 and 12. Different services, for example, are sent in said timeslots, whereby the target values set on the signal-to-interference ratio SIR of the timeslots are different. In measuring the SIR, the terminal measures the signal power of a transmission directed to a terminal to the power of a interfering signal, i.e. the power of transmissions directed to other users. It is apparent that the same service, such as speech, video image or the like, can be addressed to a terminal in the timeslots, and yet the SIR target values of the timeslots are different. In a preferred embodiment of the invention, a base station and a terminal communicate on a control cannel a SIR target value and the timeslot the target value relates to. The measurement can also be carried out without separate notification from base station 100A for example such that it is always the last timeslot in which transmission power is allocated to the terminal. This is the situation for example in FIG. 4, wherein terminal 102A measures timeslot 13. In the example of FIG. 4, while measuring timeslot 13, terminal 102A notices that the ratio of signal power to interference power is only 2 dB, although the SIR target is 3 dB. In this case, terminal 102A sends a request to increase the transmission power of the timeslot by +1 dB in the next uplink timeslot 15, which belongs to frame 300B. In the TDD mode of UMTS, the terminal sends the power adjust command in a TPC indicator (Transmission Power Control). Base station 100A receives timeslot 15 belonging to frame 300B and adjusts the transmission power to be transmitted to the terminal by +1 dB in the next frame 300C in all timeslots 3, 6 and 13 to be sent to the terminal. According to an embodiment of the inventive idea of the present invention, base station 100A thus adjusts transmission power in all timeslots of terminal 102A based on the TPC value based on the measurements of one timeslot. In this case it should be noted that if the SIR experienced by the terminal in some timeslot changes, a significant reason for an impaired SIR is a change in the location of the terminal with respect to the base station, whereby the terminal is likely to experience similar weakening of the SIR also in other timeslots.

In a preferred embodiment of the invention, the terminal sends measurement reports on connection quality to the base station. A measurement report is sent for example once per each frame in those timeslots of the reported SIR, in which transmission power is allocated to the user. Furthermore, the interference level of each timeslot in a frame can be reported in the measurement reports. In a preferred embodiment, the base station uses the measurement reports for adjusting the power of the following frame(s). With reference to for example FIG. 4, let us assume that terminal 102A is the only user in timeslots 3, 6 and 13 and sends to the base station a measurement report including interference levels 90 dBm, −120 dBm, −120 dBm, respectively. In this case, the base station preferably increases the power level of timeslot 3 more than the power ratio estimates and power control command indicate.

In an embodiment of the invention, base station 100A also estimates the relationship between transmission power and interference power based on estimated traffic. In practice, this means that, having sent frame 300A, base station 100A starts to keep a record of traffic that is to be sent in the next frame 300C. In the example of FIG. 4, base station 100A notices in timeslot 6 that the power P_{w} of a transmission directed to terminal 102A has dropped too low with respect to the interference power Pᵢ, which refers to traffic predicted, i.e. scheduled to other terminals than terminal 102A. Since base station 100A already received a command to raise transmission power by +1 dB from terminal 102A, for example +1 dB more transmission power is enough to raise the power ratio P_{w}/Pᵢ to the desired level. In a preferred embodiment of the invention, the base station first evens out the ratio P_{w}/Pᵢ to the right level, such as to the level of a preset threshold value. A threshold value may for example determine that the power ratio is 0.10. The TPC command issued by a user is not taken into account until after the power ratio is calculated.

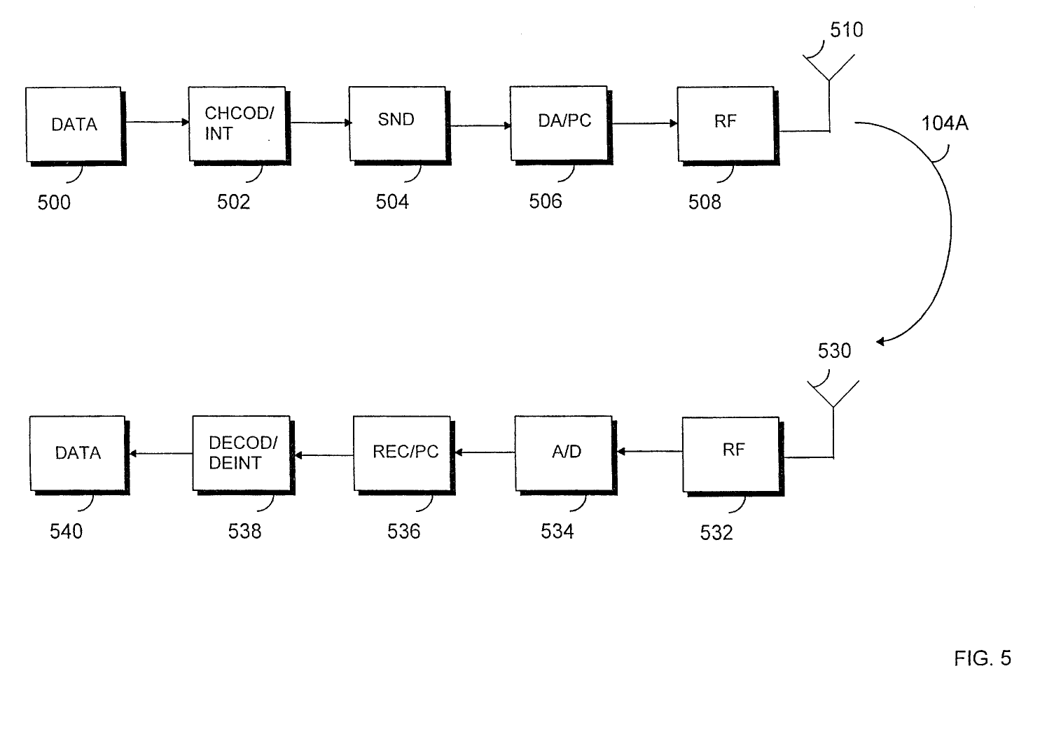

In the following, the invention will be described with reference to FIG. 5, which shows the block diagram of a CDMA transmitter and receiver by means of an embodiment. The transmitter is shown by means of blocks 500-510 and the receiver by means of blocks 530-540. Since the radio connection between transmitter 500-510 and receiver 530-540 is bi-directional, in practice both the base station of the mobile network and the terminal act as transmitter and receiver. For the sake of clarity, FIG. 5 only shows a situation wherein the base station acts as transmitter and the terminal, such as a mobile station, as receiver, i.e. downlink transmission. Data block 500 shows the hardware parts of the base station that are needed to generate user speech or data in the transmitter. In block 502, channel coding and interleaving, for example, are adapted to the information, composed of symbols. Channel coding and interleaving are used to ensure that the transmitted information can be restored in the receiver although not all information bits are received. Block 504 shows multiplication by spreading code and spreading into wideband performed on the information to be sent. Conversion from digital into analog form takes place in block 506. Before being converted into analog, a signal is subjected to power control. Power control is carried out for example such that the higher the transmission power used for sending a user signal, the higher the coefficient by which user signal chips are multiplied before a combination signal to be sent to radio path 104A is created. In unit 506, power levels of the user signal and interfering signals are compared with each other and with a threshold value, and, when threshold value comparison so indicates, the power level of the user signal is adjusted so that it fulfils the threshold value. After radio frequency parts 508, the combination signal is transferred by antenna parts 510 for transmission to downlink radio path 104A.

FIG. 5 shows a CDMA receiver 530-540 comprising antenna parts 530 for receiving a wideband signal. From antenna 530, the signal is transferred to radio frequency parts 532, from where the signal is transferred to A/D converter 534 for conversion from analog to digital form. In receiver block 536, attempts are made to separate the user signal from the received CDMA signal. Separation takes place for example by composing symbol estimates from the user signal, and the symbol estimates can be improved by subjecting the information to one or more interference cancellation steps. In a preferred embodiment, receiver block 536 in for example a RAKE type of receiver comprises a delay estimator for estimating the delays of multipath-propagated components and allocating the strongest of them to RAKE branches. In receiver block 536, user signals are regenerated and combined into an interfering signal that can be subtracted from the received combination signal. Herein, the signal-to-interference ratio is also estimated in unit 534 by comparing the power level of the user signal with the power level of the interfering signal. Once final symbol estimates are generated from the signal, it is directed to block 538 for removal of deinterleaving and channel coding. User data is then directed in the receiver to data processing routines 540, which in the case of for example a mobile station means a handset for presenting speech to a user. It is apparent that the transmitter and the receiver also comprise other parts than those described above in connection with FIG. 5, but their explanation is not relevant to describing the invention.

The invention is preferably implemented in a network part of a radio system using software, whereby for example base station 100A to 100D comprises a microprocessor, wherein the functionalities of the described method are implemented as software. It is apparent to a person skilled in the art that a network part can also refer to a disintegrated system, whereby the method steps are implemented in one or more base stations and/or base station controllers. The invention can also be implemented for example using hardware solutions providing the required functionality, e.g. as ASIC (Application Specific Integrated Circuit) or utilizing separate logics components.

Although the invention is described above with reference to examples according to the accompanying drawings, it is apparent that the invention is not limited thereto, but can be modified in a variety of ways within the scope of the inventive idea disclosed in the attached claims.

1. A method for power control in a radio system, in which radio system a radio transmission between a network part in the radio system and terminals located in the coverage area of the network part is transmitted in a frame, comprising:
allocating downlink transmission power for a terminal in one or more timeslots determined by said frame, and
producing transmission power in a transmission to the terminal timeslot-specifically such that the power ratio of the transmission power of a radio transmission to the terminal in the timeslot and the interference power caused by transmissions to other terminals exceeds a threshold value set on the power ratio in the timeslot.

2. A method as claimed in claim 1, wherein the network part comprises one or more of the following: one or more base stations, one or more base station controllers.

3. A method as claimed in claim 1, wherein the threshold value set on the power ratio is determined based on the service to be sent in the timeslot.

4. A method as claimed in claim 1, wherein the threshold value set on the power ratio is determined based on the service class of the terminal.

5. A method as claimed in claim 1, further comprising:
measuring the signal strength of a transmission addressed to a terminal and the interfering signal strength of the timeslot in the terminal in a timeslot in which transmission power is allocated to the terminal;
creating the signal-to-interference ratio of signal strength to interfering signal strength in the terminal;
comparing the signal-to-interference ratio in the terminal with a preset threshold value, and if the signal-to-interference ratio is at least equal to the threshold value, sending a power adjust command from the terminal to the network part;
adjusting the transmission power of transmissions addressed to the terminal in the network part based on the power adjust command in all those timeslots of the next frame in which transmission power is allocated to the terminal.

6. A method as claimed in claim 5, further comprising:
sending information from the network part to the terminal indicating in which timeslot the signal-to-interference ratio is to be measured.

7. A method as claimed in claim 1, wherein the radio system is a radio system using the code division multiple access method (CDMA) and the transmissions of different terminals in a timeslot are separated based on individual spreading codes allocated to the terminals.

8. A method as claimed in claim 1, wherein the uplink and downlink transmission directions are separated from one another in the radio system using time division duplex (TDD).

9. A method as claimed in claim 1, further comprising:
sending a measurement report on the signal-to-interference ratio (SIR) from the terminal to the network part regarding all timeslots in which transmission power is allocated to the terminal;
using the measurement report received from the terminal in the network part in determining the transmission power of the transmission of the frame to be sent next and directed to the terminal.

10. A network part in a radio system, arranged to transmit radio traffic to terminals located in the coverage area of the network part in a frame, the network part being arranged to allocate downlink transmission power in at least one timeslot to a given terminal from timeslots determined by said frame, wherein:
the network part is arranged to produce transmission power in a transmission to a terminal timeslot-specifically such that the power ratio of the transmission power of a radio transmission to the terminal in each timeslot and the interference power caused by transmissions to other terminals exceeds a threshold value preset on the power ratio in the timeslot.

11. A network part as claimed in claim 10, wherein the network part comprises one or more of the following: one or more base stations, one or more base station controllers.

12. A network part as claimed in claim 10, wherein the network part is arranged to determine the threshold value set on the power ratio based on the service to be sent in the timeslot.

13. A network part as claimed in claim 10, wherein the network part is arranged to determine the threshold value set on the power ratio based on the service class of the terminal.

14. A network part as claimed in claim 10, wherein:
the network part is arranged to receive a power adjust command from the terminal, related to one such timeslot in which transmission power is allocated to the terminal;
the network part is arranged to use the power adjust command to adjust the transmission power of transmissions directed to the terminal in all those timeslots of the next frame wherein transmission power is allocated to the terminal.

15. A network part as claimed in claim 14, wherein the network part is arranged to send information to the terminal about the timeslot of the frame wherein the power ratio will be measured.

16. A network part as claimed in claim 10, wherein the radio system is a radio system using the code division multiple access method, wherein the transmissions of different terminals in a timeslot are separated based on individual spreading codes allocated to the terminals.

17. A network part as claimed in claim 10, wherein the uplink and downlink transmission directions are separated from one another in the radio system using time division duplex (TDD).

18. A network part as claimed in claim 10, wherein the network part is arranged to receive a measurement report on the signal-to-interference ratio (SIR) from the terminal regarding all timeslots in which transmission power is allocated to the terminal;
the network part is arranged to use the measurement report received from the terminal in determining the transmission power of the transmission of the frame to be sent next and directed to the terminal.

19. A radio system comprising a network part and one or more terminals in radio connection to the network part, where radio traffic on the radio connection between the network part and the terminal is transmitted in a frame, and where the network part is arranged to allocate downlink transmission power in at least one timeslot to a given terminal from timeslots determined by said frame, wherein:
the network part is arranged to produce the transmission power in a transmission to a terminal timeslot-specifically such that the power ratio of the transmission power of a radio transmission to the terminal in each timeslot and the interference power caused by transmissions to other terminals exceeds a threshold value preset on the power ratio in the timeslot.

20. A radio system as claimed in claim 19, wherein the network part comprises one or more of the following: one or more base stations, one or more base station controllers.

21. A radio system as claimed in claim 19, wherein the network part is arranged to determine the threshold value set on the power ratio based on the service to be sent in the timeslot.

22. A radio system as claimed in claim 19, wherein the network part is arranged to determine the threshold value set on the power ratio based on the service class of the terminal.

23. A radio system as claimed in claim 19, wherein:
the terminal is arranged to measure, in a timeslot in which transmission power is allocated to the terminal, the signal strength of a transmission directed to the terminal and the interfering signal strength of the timeslot;
the terminal is arranged to measure the signal-to-interference ratio of signal strength to interfering signal strength;
the terminal is arranged to compare the signal-to-interference ratio with a preset threshold value, and if the signal-to-interference ratio is at least equal to the threshold value, to send a power adjust command to the network part;
the network part is arranged to adjust the transmission power of transmissions addressed to the terminal based on the power adjust command in all those timeslots of the next frame in which transmission power is allocated to the terminal.

24. A radio system as claimed in claim 23, wherein the network part is arranged to send information to the terminal and the terminal is arranged to receive information from the network part indicating in which timeslot the signal-to-interference ratio is to be measured.

25. A radio system as claimed in claim 19, wherein the radio system is a radio system using the code division multiple access method, wherein the transmissions of different terminals in a timeslot are separated based on individual spreading codes allocated to the terminals.

26. A radio system as claimed in claim 19, wherein the uplink and downlink transmission directions are separated from one another in the radio system using time division duplex (TDD).

27. A radio system as claimed in claim 19, wherein the network part is arranged to receive a measurement report on the signal-to-interference ratio (SIR) from the terminal regarding all those timeslots in a frame in which transmission power is allocated to the terminal;
the network part is arranged to use the measurement report received from the terminal in determining the transmission power of the transmission of the frame to be sent next and directed to the terminal.
